(19) United States
(12) Patent Application Publication
(10) Pub. No.: US 2009/0151440 A1
(43) Pub. Date: Jun. 18, 2009

(54) TIRE PROVIDED WITH A THERMOELECTRIC DEVICE

(75) Inventors: Olivier COLLONGE, Villard-Bonnot (FR); David BERTRAND, Besancon (FR); Frederic SPETLER, Lezoux (FR); Charles SALVI, Grenoble (FR)

Correspondence Address: FITZPATRICK CELLA HARPER & SCINTO, 30 ROCKEFELLER PLAZA, NEW YORK, NY, 10112, US

(73) Assignee: MICHELIN RECHERCHE ET TECHNIQUE S.A., Granges-Paccot (CH)

(21) Appl. No.: 12/173,892

(22) Filed: Jul. 16, 2008

(30) Foreign Application Priority Data
Jul. 18, 2007 (FR) 0756580

(51) Int. Cl. G01M 17/02

(52) U.S. Cl. 73/146

(57) ABSTRACT

A tire provided with a Seebeck effect thermoelectric generator to deliver electrical power to a member, the generator comprising a cold pole and a hot pole respectively in contact with a cold element and a hot element, the hot element forming a portion of the tire.

### BACKGROUND OF THE INVENTION

It is known to provide a wheel or a tire with a functional member, such as, for example: a pressure sensor; a temperature sensor; or a device for measuring deformation of the wheel or of the tire.

Generally, the functional member is active and it is needs to be powered electrically. It is known to power the functional member electrically, e.g. by means of a battery or by transmitting electromagnetic waves and converting said waves into electricity.

Another known way of powering the member consists in using a thermoelectric generator based on the Seebeck effect. A Seebeck effect thermoelectric generator is a conventional device that enables electricity to be generated from a temperature difference that exists between a hot element and a cold element that are respectively in contact with a cold pole and a hot pole of the generator. The electricity delivered by the generator increases with increasing temperature difference. Nevertheless, generating sufficient electricity to power a functional member requires very particular conditions of use and installation for the generator, since the Seebeck effect is known to provide only a small amount of electricity.

Document U.S. Pat. No. 7,209,032 proposes using a Seebeck effect thermoelectric generator for powering an electrical functional member carried by a wheel-and-tire assembly. Nevertheless, that document does not specify to which hot and cold elements need to be connected the thermoelectric generator in order to obtain sufficient electricity for powering the functional member.

### OBJECTS AND SUMMARY OF THE INVENTION

A particular object of the invention is to identify hot and cold elements for connection to a Seebeck effect thermoelectric generator in order to deliver power effectively to an electrical functional member carried by a wheel-and-tire assembly.

To this end, the invention provides a tire provided with a Seebeck effect thermoelectric generator for electrically powering a member, the generator comprising a cold pole and a hot pole respectively in contact with a cold element and a hot element, the hot element being an element forming part of the tire.

As it rotates, the tire deforms, in particular on passing through the area that is in contact with the ground. Specifically, the sidewalls of the tire are subjected to repeated flexing. This deformation leads to the tire heating up considerably.

The invention thus proposes using an element that forms part of the tire and that is heated by the tire rotating as the hot element for connection to the hot pole of the Seebeck effect thermoelectric generator.

Positioning the generator on the tire also presents other advantages.

Firstly, the tire presents a large internal surface area that is available for supporting the generator. It is known that in order to increase the amount of electricity produced by the thermoelectric generator, one solution consists in placing a plurality of generators in series, thereby requiring a support of large dimensions.

In addition, the temperature of a tire is relatively constant while it is in use, unlike the temperature of the wheel which is subjected to the influence of the brake disks whose temperature can vary. This therefore makes it possible to produce electricity in substantially constant manner.

A tire of the invention may also include one or more of the following characteristics.
The hot element forms a portion of the rubber liner of the tire. The rubber liner, in particular the surface of the rubber liner that is in contact with the air inside the tire, is easily accessible from the inside of the tire. The thermoelectric generator can thus be fitted simply on said inside surface and put into contact with the hot element.
The hot element is positioned in a shoulder zone of the tire. The shoulder zone of the tire connecting the tread of the tire to the sidewall is a zone that is subjected to a large amount of flexing when the tread passes through the contact area. The temperature rise of this zone is particularly large. It is therefore advantageous to position the hot element in this zone.
The hot element is positioned in a bottom zone of the sidewall of the tire.
The hot element is positioned in a zone of the bottom zone of the sidewall of the tire that is subjected to flexing. The bottom zone of a sidewall of a tire is subjected to high levels of flexing, thereby generating a particularly large temperature rise. It is therefore advantageous to position the hot element in such a zone.
The cold element forms a portion of the tire.
The cold element forms a portion of the rubber liner of the tire. When the hot element and the cold element are portions of the rubber liner of the tire, the thermoelectric generator can be fitted simply to the rubber liner of the tire, e.g. by being integrated in a rubber sheet for adhesively bonding to the rubber liner of the tire.
The cold element comprises the air inside the tire coming into contact with the cold pole. The air inside the tire is generally at a temperature well below the temperature of the tire, in particular well below the temperature in the zones where the rubber liner flexes. Consequently, there is a considerable temperature difference between the inside air and the rubber liner of the tire. This temperature difference is advantageously used by the Seebeck effect thermoelectric generator.
The tire includes an element fitted onto the rubber liner of the tire and arranged and shaped in such a manner as to heat up during rotation of the tire, thereby constituting the hot element. It is possible to raise the temperature of the rubber liner of the tire artificially by providing a fitted element having the sole function of creating local stresses. The presence of such local stresses generates a hot point on the surface of the tire.
The fitted element is made of rubber that presents greater dissipation than the rubber liner.
The tire further comprises means for deforming the fitted element during rotation of the tire.

### BRIEF DESCRIPTION OF THE DRAWINGS

The invention can be better understood on reading the following description given purely by way of example and made with reference to the accompanying drawings, in which:

FIG. 1 is a diagram explaining the Seebeck effect;

FIG. 2 is a diagram of a Seebeck effect thermoelectric generator for fitting to a tire of the invention;

FIG. 3 is a schematic diagram of a circuit for powering a functional member a functional member by means of the thermoelectric generator of FIG. 2;

FIG. 4 is a diagrammatic axial section view of a tire in a first embodiment of the invention, showing two possible locations for the thermoelectric generator;

FIG. 5 is a diagrammatic axial section view of a tire in a second embodiment of the invention; and

FIG. 6 is a diagrammatic axial section view of a tire of the invention provided with members that are fitted thereon and shaped in such a manner as to heat up.

### MORE DETAILED DESCRIPTION

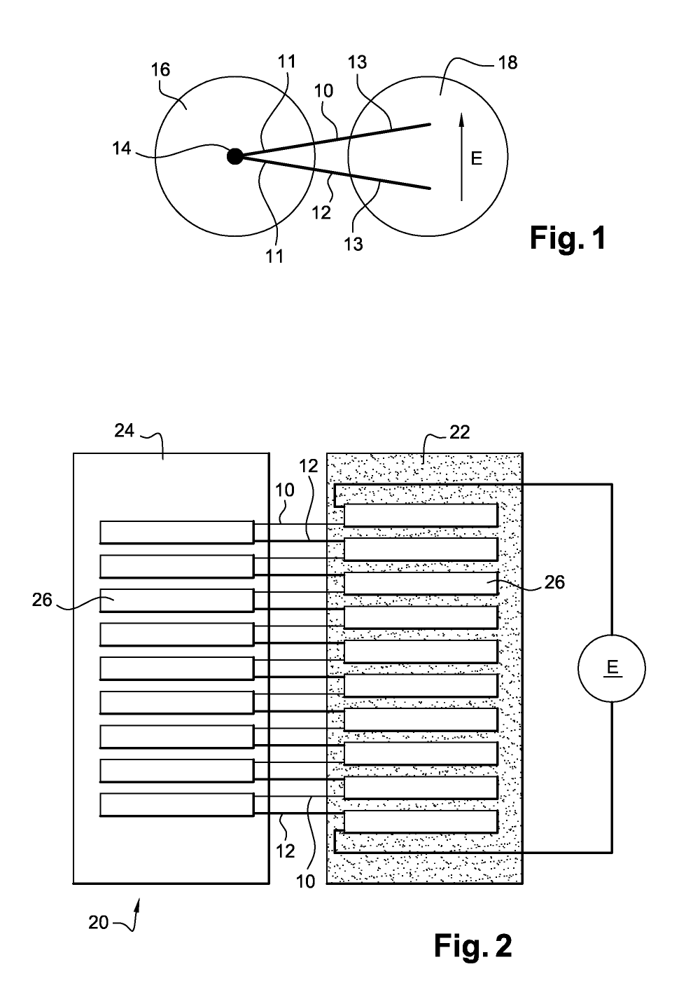

FIG. 1 is a diagram for explaining the principle of the Seebeck effect. The Seebeck effect, or thermocouple effect, makes use of the properties of certain materials that produce an electric voltage under the effect of a temperature difference.

FIG. 1 shows a pair of wires 10 and 12, each having a respective first end 11 connected to the first end of the other by a weld 14, and a respective second end 13. The first ends 11 are in contact with a cold element 16 and the second ends 13 are in contact with a hot element 18.

In this configuration, the Seebeck effect produces a voltage E between the second ends 13 of the two wires 10 and 12 that is proportional to the temperature difference between the cold and hot elements 16 and 18. The coefficient of proportionality α is a function of materials constituting the wires 10 and 12.

By way of example, the coefficient α is equal to 70 microvolts per kelvin (μV/K) when the wires are made of chromel (CrNi) and of constantan (CuNi), or is equal to 200 μV/K when the wires are made of bismuth telluride (Bi₂Te₃).

FIG. 2 shows a Seebeck thermoelectric generator 20 comprising a plurality of pairs of wires 10 and 12 having their ends that are to be raised to different temperatures in order to produce a voltage.

The pairs of wires are connected electrically in series so that the voltage E delivered at the terminals of the generator is substantially proportional to the number of pairs in series.

The generator 20 has a cold pole 22 and a hot pole 24, designed respectively to come into contact with the cold element 16 and the hot element 18, and having the ends of the pairs of wires connected respectively thereto. These two poles 22 and 24 comprise, by way of example, respective flat masses of rubber.

To optimize temperature conduction between the surfaces 22 and 24 and the weld points between the wires 10 and 12, the generator is provided with a copper grid 26 that encourages heat distribution.

The invention proposes making use of a thermoelectric generator, such as the generator shown in FIG. 2, for the purpose of powering a functional member 28, e.g. a pressure sensor.

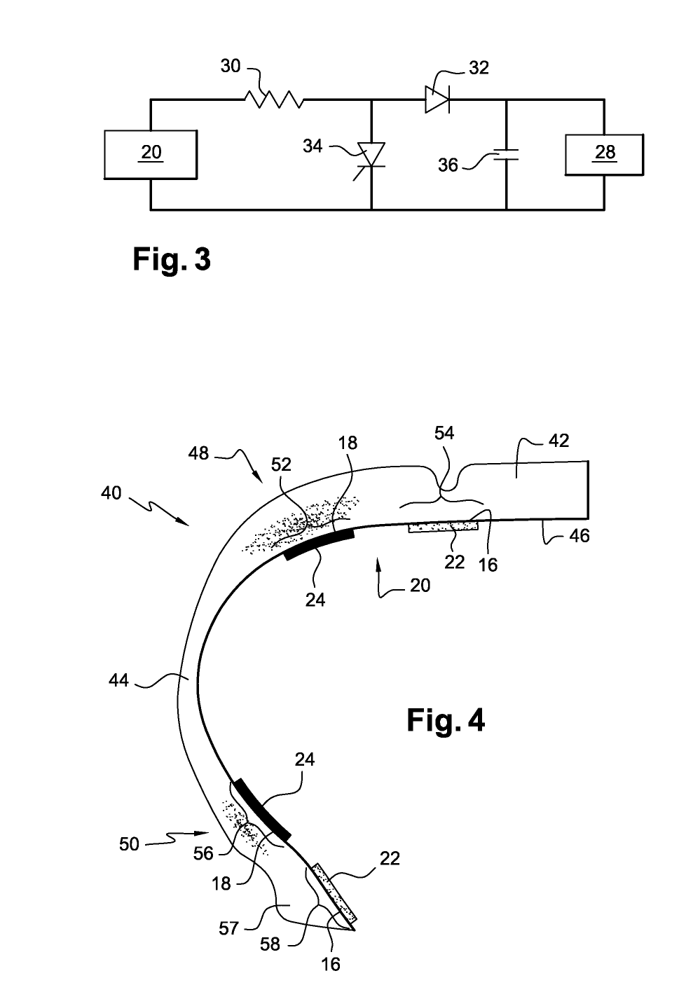

An example of a power supply circuit for the member 28 is shown in FIG. 3. The power supply circuit comprises a resistor 30, a diode 32, a control diode 34, and a capacitor 36.

The function of the capacitor 36 is to store energy during stages when the member 28 is not consuming energy so as to be able to deliver said energy during stages when it is required.

The resistor 30 and the diodes 32 and 34 serve to control the voltage available across the terminals of the capacitor 36 and to adjust the frequency with which the voltage delivered to the terminals of the capacitor 36 alternates.

FIG. 4 shows a tire 40 fitted with a thermoelectric generator 20 as shown in FIG. 2. For reasons of clarity, only the poles 22 and 24 of the generator 20 are shown in FIG. 4.

The tire 40 comprises a tread 42 situated at the crown of the tire and two sidewalls 44, only one of which is shown. The portion of the tire 40 that comes into contact with the air inside the tire is made of rubber liner 46.

The portion of the tire 40 interconnecting the tread 42 of the tire and the sidewall 44 thereof is referred to as the shoulder zone 48. The bottom portion of the sidewall 44 is referred to as the bottom zone 50.

The shoulder zone 48 and the bottom zone 50 are zones that are subjected to high levels of flexing while the tire is running, thereby leading to local heating of the tire, which is represented in FIG. 4 by shaded zones.

In a first embodiment of the invention as shown in FIG. 4, the poles 22 and 24 of the generator 20 are in contact with cold and hot elements 15 and 18, both of which form portions of the tire 40, and more precisely of the rubber liner 46 of the tire.

Two possible dispositions for the generator 20 on the tire 34 are shown in FIG. 4.

In a first disposition, the hot pole 24 of the generator 20 is in contact with a zone 52 of the rubber liner 46 that forms a portion of the shoulder zone 48 of the tire 34 and that constitutes a hot element 18.

The cold pole 22 of the generator 20 is in contact with a zone 54 of the rubber liner 46 that is situated under the tread 42 and that constitutes a hot element 16. The zones 52 and 54 are selected in such a manner that the temperature difference between these two zones is a maximum. In this first disposition, the temperature difference is about 40° C. when running at 100 kilometers per hour (km/h) under ordinary conditions of use for the tire.

In a second disposition, the hot pole 24 of the generator 20 is in contact with a zone 56 of the rubber liner 46 that forms a part of the bottom zone 50 of the tire 34 and that constitutes a hot element 18.

The cold pole 22 of the generator 20 is in contact with a zone 58 of the rubber liner 46 that is situated over the bead 57 of the tire and that constitutes a cold element 16. The zones 56 and 58 are selected in such a manner that the temperature difference between these two zones is at a maximum. In this second disposition, the temperature difference is about 30° C. under ordinary conditions of use when running at 100 km/h.

Such temperature differences are large enough for the generator 20 to produce a voltage suitable for powering the member 28. By way of example, a generator 20 having ten chromel-constantan thermocouples made up of wires 10 and 12, coming into contact with hot and cold points that are separated by 34° C. delivers a voltage of 23 millivolts (mV) at a power of 165 microwatts (μW).

These two dispositions are particularly advantageous for positioning the poles of the generator since the shoulder zone 48 and the bottom zone 50 of the tire are the hottest zones of the tire.

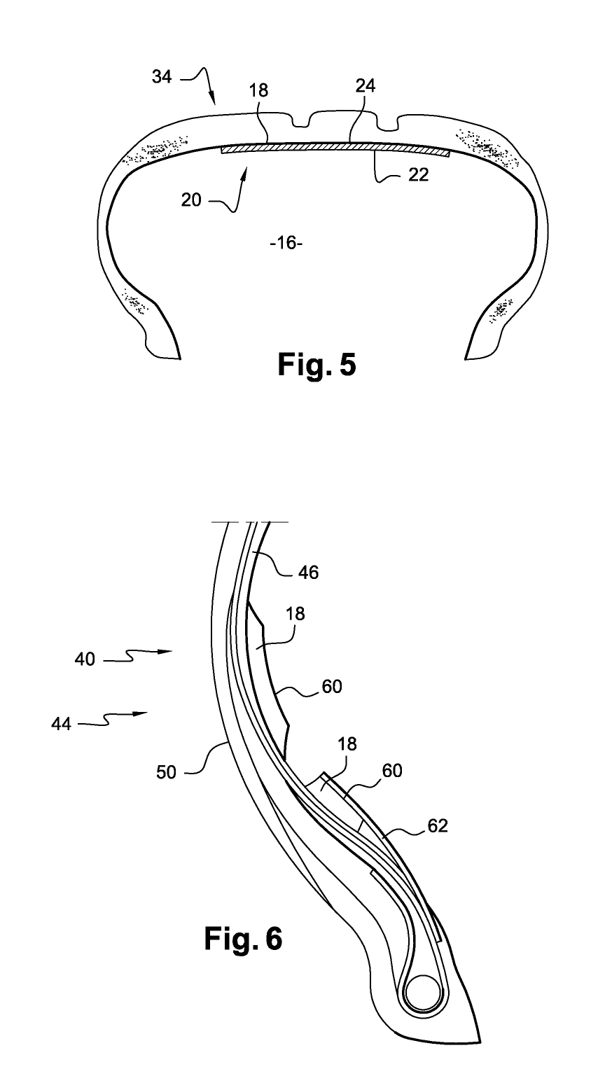

In a second embodiment of the invention, as shown in FIG. 5, the hot pole 24 of the generator 20 is in contact with a hot element 18 that is an element constituting the rubber liner 46 of the tire 40, and the cold pole 22 of the generator is in contact with a cold element 16 that is constituted by the air inside the tire 40 and in contact with the cold pole 22. The temperature of the air inside the tire under normal running conditions is about 30° C., thereby making it possible to obtain a considerable temperature difference between the cold and hot points.

In a variant of the invention that is applicable to both of the above-described embodiments and that is shown in FIG. 6, the tire 40 has an element 60 fitted onto the rubber liner 46 of the tire 40 and arranged and shaped in such a manner as to heat during running of the tire, and to constitute the hot element 18. The element 60 comprises, by way of example, a mass of rubber in the form of a slab or a circumferential rubber ring. The element 60 is preferably made of rubber having a highly dissipative formulation, with a high level of hysteresis.

The element 60 can be located at various positions within the tire.

In a first position (not shown), the element 60 is disposed under the tread.

In a second position, as shown in FIG. 6, the element 60 is placed in a zone where the bottom zone 50 of the sidewall 44 of the tire flexes.

In a third position, as shown in FIG. 6, the element 60 is disposed on the sidewall, close to the bead 57 of the tire and is interposed between the rubber liner and a metal blade 62 constituting means for deforming the element 60, in particular by applying shear to the mass of rubber. For this purpose, the metal blade has one end connected to the bead of the tire so that during rotation and deformation of the tire, the free end of the blade moves away from and towards the rubber liner so as to subject the element 60 to shear.

In all three of these positions, the temperature of the element 60 is higher than the temperature that the rubber liner would have if the element 60 were not present. Consequently, by increasing the temperature of the hot element to which the hot pole of the generator 20 is connected, the temperature difference is increased between the hot and cold elements, thereby enabling the voltage produced by the generator 20 to be increased.

What is claimed is:

1. A tire provided with a Seebeck effect thermoelectric generator for electrically powering a member, the generator comprising a cold pole and a hot pole respectively in contact with a cold element and a hot element, the hot element forming part of the tire.

2. A tire according to claim 1, in which the hot element forms a portion of the rubber liner of the tire.

3. A tire according to claim 1, in which the hot element is positioned in a shoulder zone of the tire.

4. A tire according to claim 1, in which the hot element is positioned in a bottom zone of the sidewall of the tire.

5. A tire according to claim 4, in which the hot element is positioned in a zone of the bottom zone of the sidewall of the tire that is subjected to flexing.

6. A tire according to claim 1, in which the cold element forms a portion of the tire.

7. A tire according to claim 6, in which the cold element forms a portion of the rubber liner of the tire.

8. A tire according to claim 1, in which the cold element comprises the air inside the tire coming into contact with the cold pole.

9. A tire according to claim 1, including an element fitted onto the rubber liner of the tire and arranged and shaped in such a manner as to heat up during rotation of the tire, thereby constituting the hot element.

10. A tire according to claim 9, in which the fitted element is made of rubber that presents greater dissipation than the rubber liner.

11. A tire according to claim 9, further comprising means for deforming the fitted element during rotation of the tire.
